(19) United States
(12) Patent Application Publication
(10) Pub. No.: US 2014/0006926 A1
(43) Pub. Date: Jan. 2, 2014

(54) SYSTEMS AND METHODS FOR NATURAL LANGUAGE PROCESSING TO PROVIDE SMART LINKS IN RADIOLOGY REPORTS

(71) Applicants: Vijaykalyan Yeluri, Campbell, CA (US); Vijay Kumar Reddy Arlagada, Barrington, IL (US); Bao Do, Stanford, CA (US); Christopher Frederick Beaulieu, Stanford, CA (US)

(72) Inventors: Vijaykalyan Yeluri, Campbell, CA (US); Vijay Kumar Reddy Arlagada, Barrington, IL (US); Bao Do, Stanford, CA (US); Christopher Frederick Beaulieu, Stanford, CA (US)

(21) Appl. No.: 13/538,751

(22) Filed: Jun. 29, 2012

(51) Int. Cl. G06F 17/00

(52) U.S. Cl. 715/234

(57) ABSTRACT

Certain examples provide systems, apparatus, and methods to facilitate automated processing of report text to associate text with external content to be accessed via the report. An example method includes automatically processing report text according to natural language processing of the text to identify a text element in the report associated with content external to the report. The example method includes associating the identified text element in the report with a link to the identified content external to the report to structure the report with reference to the external content. The example method includes providing the structured report for access and manipulation by a user.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD

The present generally relates to computerizing reading and review of diagnostic images. More particularly, the present invention relates to real-time (including substantially real-time) analysis and reporting of information related to diagnostic images.

### BACKGROUND

In many cases, in order to diagnose a disease or injury, a medical scanning device (e.g., a computed tomography (CT) scanner, magnetic resonance imager (MRI), ultrasound machine, etc.) is used to capture an image of some portion of a patient's anatomy. After the acquisition of the image, a trained physician (e.g., radiologist) reviews the created images (usually on a computer monitor), renders an interpretation of findings and prescribes an appropriate action. This example becomes more complex in that current diagnostic imaging departments provide extensive information regarding the human anatomy and functional performance presented through large numbers of two- and three-dimensional images requiring interpretation. Diligent interpretation of these images requires following of a strict workflow, and each step of the workflow presumes visual presentation in certain order of certain image series from one or multiple exams and application of certain tools for manipulation of the images (including but not limited to image scrolling, brightness/contrast, linear and area measurements, etc.).

### BRIEF SUMMARY

Certain embodiments of the present invention provide systems, apparatus, and methods to automatically process text reports to include reference to associated external content for retrieval via the structured report.

Certain embodiments provide a computer-implemented method to automatically process report text to associate report text with external content. The example method includes automatically processing report text according to natural language processing of the text to identify a text element in the report associated with content external to the report. The example method includes associating the identified text element in the report with a link to the identified content external to the report to structure the report with reference to the external content. The example method includes providing the structured report for access and manipulation by a user.

Certain embodiments provide a tangible computer-readable storage medium having a set of instructions stored thereon which, when executed, instruct a processor to implement a method to automatically process report text to associate report text with external content. The example method includes automatically processing report text according to natural language processing of the text to identify a text element in the report associated with content external to the report. The example method includes associating the identified text element in the report with a link to the identified content external to the report to structure the report with reference to the external content. The example method includes providing the structured report for access and manipulation by a user.

Certain embodiments provide a report processing system to facilitate automated natural language processing and external content association in a radiology report. The example system includes a memory to store data and instructions and a processor. The example processor is arranged to automatically process report text according to natural language processing of the text to identify a text element in the report associated with content external to the report. The example processor is to associate the identified text element in the report with a link to the identified content external to the report to structure the report with reference to the external content. The example processor is to provide the structured report for access and manipulation by a user.

### BRIEF DESCRIPTION OF SEVERAL VIEWS OF THE DRAWINGS

FIGS. 1-2 illustrate example reports and associated image content.

FIG. 3 illustrates an example report processing system using natural language processing to enhance clinical reports.

FIG. 4 illustrates an example stored report processing and enhancement system.

FIG. 5 illustrates a flow diagram for a method to enhance a report using natural language processing.

FIG. 6 depicts an example clinical enterprise system for use with systems, apparatus, and methods described herein.

FIG. 7 is a block diagram of an example processor system that may be used to implement the systems, apparatus and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Certain examples help facilitate computerized reading of diagnostic images. Certain examples relate to any clinical information system used for collaboration and sharing of real-time (including substantially real-time accounting for system, transmission, and/or memory access delay, for example) information related to visualization and/or multimedia objects. Visualization objects can include but are not limited to images, reports, and results (e.g., lab, quantitative, and/or qualitative analysis post- and/or pre-reading), for example. Multimedia objects can include but are not limited to audio and/or video comments from one or more of the collaborators, images, documents, audio and/or video of references materials, for example

Certain examples help facilitate diagnostic reading of digital medical exams, such as digital radiology imaging. In many cases, in order to diagnose a disease or injury, a medical scanning device (e.g., a computed tomography (CT) scanner, magnetic resonance imager (MRI), ultrasound machine, etc.) is used to capture an image of some portion of a patient's anatomy. After the acquisition of the image, a trained physician (e.g., radiologist) reviews the created images (usually on a computer monitor), renders an interpretation of findings and prescribes an appropriate action. This example becomes more complex in that current diagnostic imaging departments provide extensive information regarding the human anatomy and functional performance presented through large numbers of two- and three-dimensional images requiring interpretation. Diligent interpretation of these images requires following of a strict workflow, and each step of the workflow presumes visual presentation in certain order of certain image series from one or multiple exams and application of certain tools for manipulation of the images (including but not limited to image scrolling, brightness/contrast, linear and area measurements, etc.).

Radiology reports are textual documents that contain findings and interpretations associated with a radiology exam. As radiology studies become more complex, finding a relevant image described in the report is more challenging. For example, a whole body CT for tumor surveillance may include thousands of images, or a knee MRI may include several hundred images and multiple sequences. Further, clinicians using web-based viewers have limited bandwidth.

Certain examples provide systems and methods to mark up and generate semantic elements in radiology reports. For example, image references to an associated radiology exam can be linked and/or otherwise referenced in the report using natural language processing. Certain examples are applicable to all settings in which radiology reports can be found, including, but not limited to, picture archiving and communication systems (PACS), emails, voice recognition and report authoring software, and electronic medical records. In addition to images, references can also be made to a patient chart that is available in an electronic medical record system, for example.

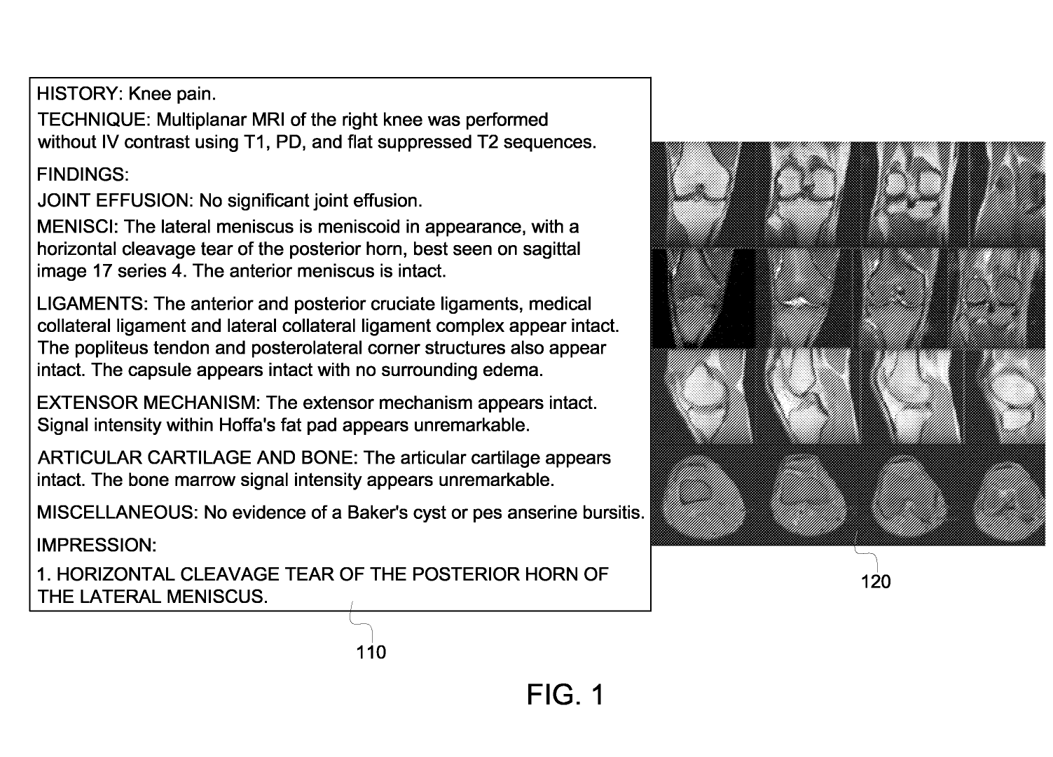

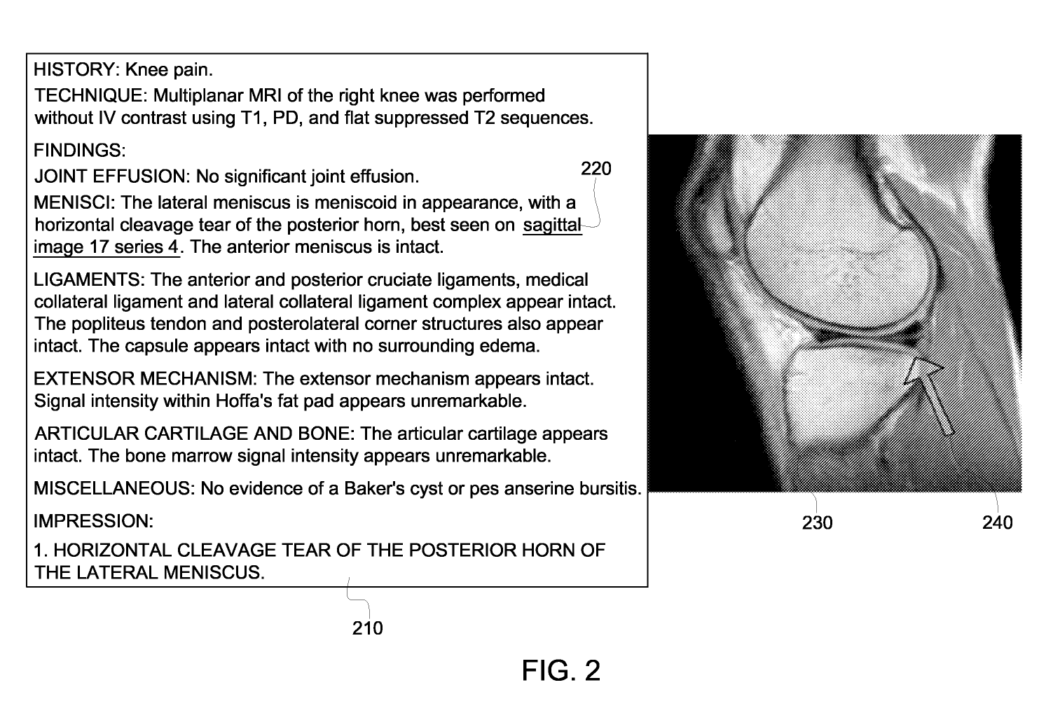

As illustrated in the example of FIG. 1, a report 110 and a series of images 120 can be related, both useful to a clinician in reviewing image and associated analysis. As demonstrated in FIG. 2, a report 210 can be processed to identify one or more words/phrases for translation from text to an association with a link and/or other reference 220. In the example of FIG. 2, a link 220 inserted in the report 210 as a result of natural language processing connects the clinician to an associated image 230. The image 230 includes a reference or pointer 240 to a particular feature in the image (e.g., a meniscus in the patient knee). Selecting the link 220 provides the image 230, as a separate image, inline image, floating/pop-up image, etc.

Often a second opinion from a specialist or peer in the same field is required and/or desired, and the person might not be physically present at the same workstation to view the same images. In order to compensate for this, the reading radiologist may provide a report that includes links and/or other references to external content (e.g., images, electronic medical record data, lab results, etc.) for reader access and review. Links/references can be provided in a report as a user is generating the report (e.g., via natural language processing during dictation) or via an inline processing tool to analyze a legacy saved report as it is and/or before it is opened for review by a user, for example.

Currently, radiology reports are unstructured, textual documents. As radiology studies have become more complex (e.g., from film sheets to more complex, multi plane cross-sectional studies including potentially thousands of images), it has become increasingly difficult for radiologists and other clinicians to navigate and retrieve information referenced in a report. For example, radiologists and other clinicians using limited bandwidth systems have great difficulty retrieving correct, pertinent images referenced in a radiology report. Such retrieval of content external to a report is further complicated by the fact that there are multiple vendors and user interfaces available.

Certain examples apply natural language processing (NLP) to automate creation of hyperlinks and/or other references to directly retrieve desired image(s) and/or other external content upon selection by a user. Certain examples provide a tighter integration between PACS and other information systems such as teaching files.

Other efforts to embed images into a report have been manual (i.e., a radiologist or technician pastes relevant images directly into a text document). The text remains unstructured. Certain examples apply NLP to identify image references from unstructured textual data and facilitate semantic mark up, transparently without action of the radiologist. Thus, certain examples can be implemented on legacy systems and old reports because the NLP can dynamically generate semantic hyperlinks in real time, as the report is being opened. Furthermore, certain examples integrate the report with an entire study, not only specific key images.

In certain examples, NLP can be applied to a text report to automatically create a hyperlink, embed relevant image(s) and/or other content (e.g., lab results, electronic medical record (EMR) data, etc.) directly as inline in the report, and/or enable float of the external content in the report. In certain examples, hyperlinks can be created manually.

Certain examples can interact with PACS, PACS export studies, EMR, voice recognition/report authoring software, etc. In certain examples, a hyperlink is created around relevant finding(s) in a report that link to relevant image(s) in the exam.

Automation of text processing in a message helps reduce or avoid performance of manual actions by a user, for example. Certain examples can be extended to sharing data by automatically sending the data using an email or short message service (SMS), for example. If a person asks: “Can you email me or can you text me?”, for example, a collaboration exchange can automatically be prepared. Using automated text processing, a user can avoid performing precise measurements and/or other actions with respect to images that can otherwise be tedious if the user is viewing and manipulating the image on a mobile device, for example.

In certain examples, using natural language processing, image and/or other reference(s) are recognized in radiology reports to automatically create semantic mark-up or hyperlink. Hyperlinks can be generated during dictation, when the report is finalized, at the time of data export, or dynamically when a report is displayed, depending on which point the vendor desires to integrate the NLP.

The user can then click on the hyperlinks (or option for inline display or float) to view the relevant images and/or other external data (e.g., lab results, EMR data, etc.). Certain examples provide a tighter integration between a radiology report (e.g., metadata) and radiology images.

For example, with a PACS, radiology reports can be displayed in a PACS. Before a report is displayed, a NLP processor processes the report and identifies references to images (e.g., image number, series number, plane (axial, sagittal/lateral, coronal/frontal), sequence/kernel type for MRI or CT, etc.). A hyperlink is dynamically generated, allowing the user to simply click on the link to “jump-to” the relevant image(s). In addition, in certain examples, the user has an option to display the images as inline within the text and/or to have the images float on mouse-over. Clinicians and radiologists can thereby quickly retrieve the most relevant images, an important activity for surgical planning, diagnosis, and surveillance follow-up, for example.

Certain examples can also apply to content stored on PACS discs. In certain examples, patients can obtain exported studies with semantic hyperlinked reports, enabling referring clinicians to quickly identify relevant pathology, etc., especially since discs and viewer types may differ from a vendor a referring clinician routinely uses.

Certain examples interact with voice recognition and/or report authoring software. As the radiologist dictates the study, NLP recognizes and dynamically marks up image references in real-time, if desired. The dynamic mark-up allows the radiologist to view the relevant images quickly when signing off. Dynamic mark-up also helps eliminate erroneous image references, for example, in a resident-radiology workflow where the resident dictates a preliminary report for an attending to review. The attending can now read the report and click on the hyperlinks automatically created using NLP to look at the relevant images to verify or confirm the resident's findings.

In certain examples, hyperlinks can be generated in real-time by the NLP when a clinician opens a radiology report in the EMR. Hospitals, clinics, and even patients (e.g., universal EMR efforts by Google, HP, etc.) are adopting EMRs, and hyperlinked radiology reports can facilitate integration of radiology exam images with reports. In addition to images, similar hyperlinks can also be generated by the NLP that link to, for example, the patient's chart in the electronic medical record system to view the patient's allergies and lab results, etc.

For example, a radiologist with a smartphone (e.g., an IPHONE™) or tablet computer (e.g., an IPAD™) can provide dictation, and links and/or other references are inserted inline on the fly as dictation is done. Thus, certain examples “intelligently” (e.g., based on definitions and logic) convert dictation text to link(s) and allow selection of link(s) to image(s), patient chart and/or other EMR data, etc., from a current exam and/or other exams via the report. The report can be viewed, relayed, stored, etc.

In certain examples, an indication of accuracy and/or confidence in the report is determined For example, the NLP processor can evaluate inserted links based on report text and associated content to determine a confidence/accuracy score or rating. In certain examples, a pop-up or thumbnail of a linked image and/or other content is provided in conjunction with the report as the user is preparing it and/or as the processor is reviewing a previously written report. A user can then be prompted to confirm that the pop-up/thumbnail is the correct content to be linked. In certain examples, a user cannot sign off on the report until the user confirms the correct content (e.g., the correct image) has been linked.

As shown in the example of FIG. 1, a radiology report 110 of a knee MRI exam includes hundreds of images 120. If a clinician reads the original report 110, the clinician needs to manually scroll through the MRI study 120 to find a single key image (e.g., series 4, image 17) that includes the pathology. Alternatively, a computer system uses natural language processing (NLP) to identify all references to radiology images in the electronic text and converts these references to hyperlinks pointing directly to the images. In the post processed report 210, depicted in FIG. 2, a viewer can retrieve the image 230 directly by clicking on the hyperlink 220 (or the key image can “float” next to a mouse cursor as the viewer hovers over the hyperlink), for example. Certain examples apply to all context in which references to radiology images are found, such as radiology reports in the electronic health record, exported on a CD-ROM, or deployed on a cloud based DICOM viewer, for example.

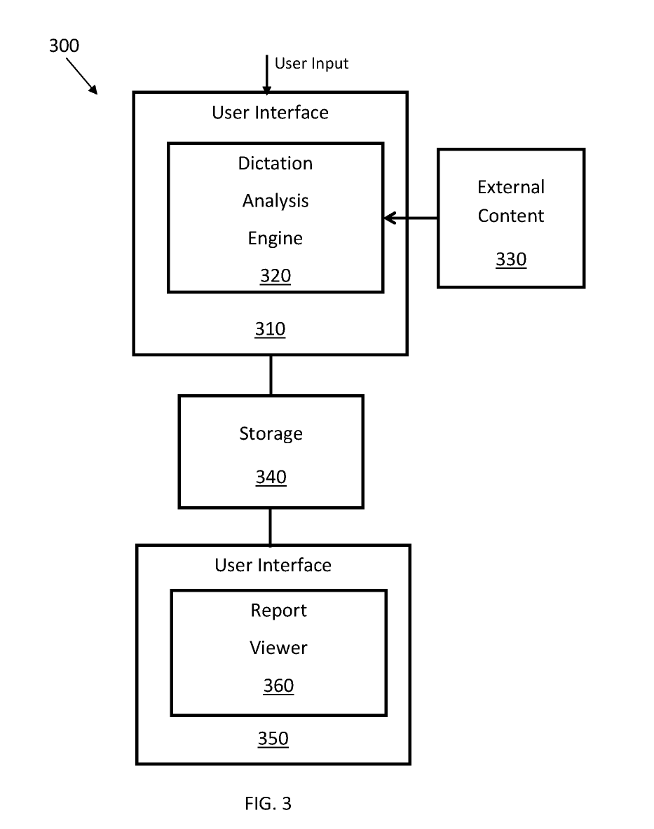

FIG. 3 illustrates an example report processing system 300 using NLP to enhance clinical reports. User input, such as radiologist dictation, is provided via a user interface 310. The user interface 310 includes a dictation analysis engine 320. The dictation analysis engine 320 receives text for the report (e.g., based on user dictation and/or typing) and processes that text according to NLP to identify semantic elements corresponding to external content 330, such as images in a PACS or image exchange, lab results, other EMR data, etc. The dictation analysis engine 320 generates links and/or other references corresponding to the identified semantic elements and provides those as part of the resulting report. A reader of the report is then able to select a link to retrieve associated information (e.g., via content retrieval, pop-up, float, etc.). The report is then structured based on the semantic elements and further analysis. The structured report can then be stored in a storage 340, such as an enterprise archive, database, data store, etc. The report can be retrieved and/or otherwise exchanged via the storage 340, for example.

For example, the report can be retrieved and displayed via a user interface 350, which may be the same as, similar to, or different than the interface 310. The interface 350 includes a report viewer 360. The viewer 360 allows a user to retrieve the report and view the report, including access to external content based on selection of links and/or other references that were automatically inserted into the report by the analysis engine 320.

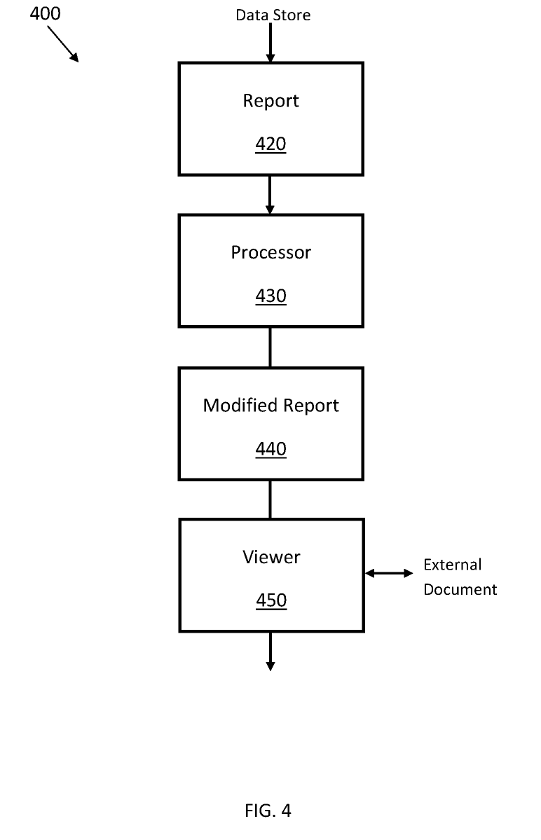

FIG. 4 illustrates an example stored report processing and enhancement system 400. In the system 400, a report 420 is provided (e.g., retrieved by a user and/or automatically by an engine or other system) from a data store and routed to a processor 430. The processor 430 analyzes the report 420 (e.g., a legacy report pulled from storage, a report being generated on-the-fly, etc.) to identify semantic elements and associate those elements with links/references to external content referred to by those elements.

For example, a reference to an image in the report 420 is identified by the processor 430 and associate the image with the text of the report 420 by structuring that text as a semantic element and providing a hyperlink to that image in the report 420. Selection of the hyperlink pulls up the image in another document view, a pop-up in the report 420, etc.

In certain examples, the processor 430 determines a confidence factor or risk factor associated with its automated correlation between report text and external content. The factor can be provided to a user, and the user may be asked to approve the automated link. For example, a pop-up window can be provided to notify the user of an automated association made by the processor 430 between report 420 text and external content. The user then must approve that association before it becomes part of the report.

The automated processing of the report 420 by the processor 430 generates a modified report 440. The modified report 440 is a structured report including user-selectable references (e.g., links) to external content associated with certain semantic elements identified in the report 440. The modified report 440 can be relayed, stored, and/or otherwise output, for example.

The modified report 440 can be accessed via a viewer 450, for example. A user can read the modified report 440 via the viewer 450. The user can select a link in the report 440 to trigger the viewer 450 to retrieve and display content (e.g., an image, lab result, etc.) from one or more external documents, for example.

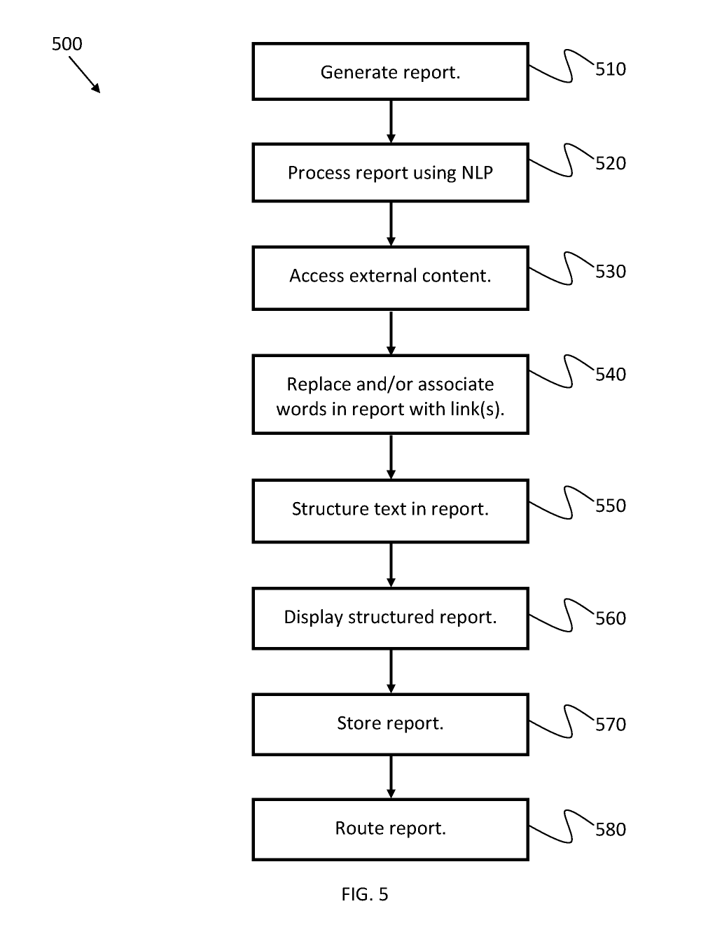

FIG. 5 depicts an example flow diagram representative of process(es) that can be implemented using, for example, computer readable instructions that can be used to facilitate reviewing of anatomical images and related clinical evidence. The example process(es) of FIG. 5 can be performed using a processor, a controller and/or any other suitable processing device. For example, the example process(es) of FIG. 5 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 5 can be implemented using coded instructions (e.g., computer readable instructions) stored on a non-transitory computer readable medium such as a flash memory, a read-only memory (ROM), a random-access memory (RAM), a CD, a DVD, a Blu-ray, a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 5 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 5 can be implemented manually or as any combination(s) of any of the foregoing techniques, for example, any combination of firmware, software, discrete logic and/or hardware. Further, although the example process(es) of FIG. 5 are described with reference to the flow diagram of FIG. 5, other methods of implementing the process(es) of FIG. 5 may be employed. For example, the order of execution of the blocks can be changed, and/or some of the blocks described may be changed, eliminated, sub-divided, or combined. Additionally, any or all of the example process(es) of FIG. 5 can be performed sequentially and/or in parallel by, for example, separate processing threads, processors, devices, discrete logic, circuits, etc.

FIG. 5 illustrates a flow diagram for a method 500 to enhance a report using NLP. At block 510, a report is generated. For example, a radiologist dictates a report that is capture as text for later reading and/or other use. At block 520, the report is processed using NLP. Natural language processing can be performed automatically on the report and/or based on user trigger (e.g., a user selecting an option via an interface) on-the-fly (e.g., real time or substantially real time) as the user is dictating/writing the report and/or later upon retrieving a previously generated report from storage.

At block 530, external content is accessed based on the NLP of the report. The NLP identifies words and/or phrases in the text of the report to be structured and associated with the external content. At block 540, words/phrases in the report are associated with and/or replaced by a reference (e.g., a link) to the relevant external content. At block 550, the report is structured based on the identified semantic elements in the text.

At block 560, the structured report is displayed. In certain examples, a user may interact with the report to approved automated associations and/or other changes made through the NLP, read the report, access linked content, etc.

At block 570, the report is stored. For example, the structured report can be stored in a PACS, a RIS, an EMR, an enterprise archive, a database, and/or other storage. At block 580, the report can be routed. For example, the report can be routed to a viewer for reading, to a system for processing, etc.

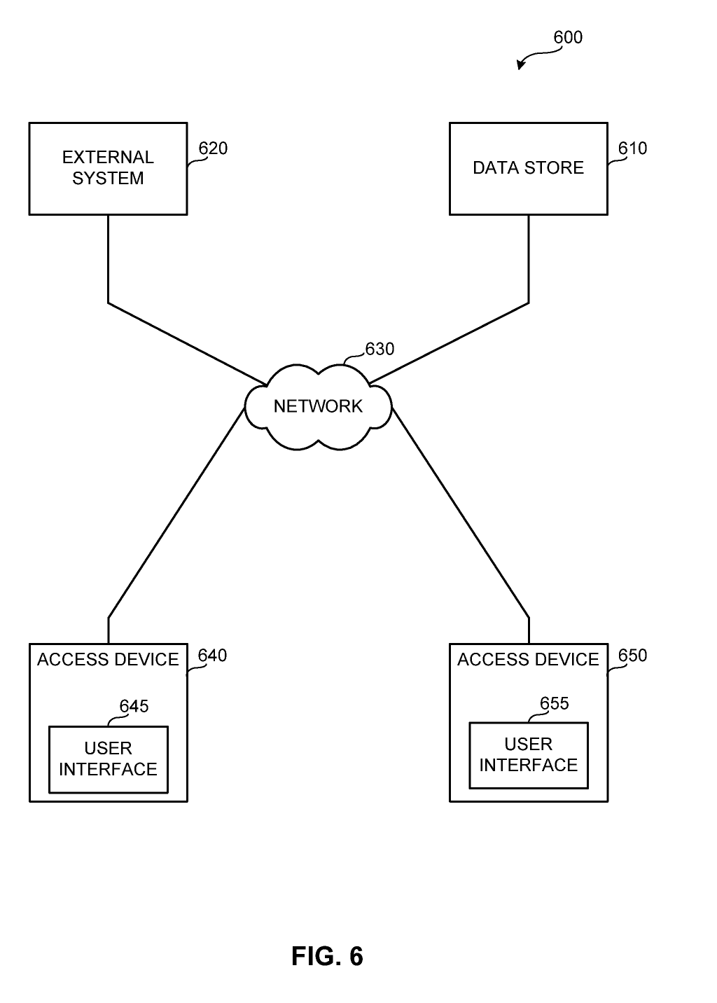

Systems and methods described above can be included in a clinical enterprise system, such as example clinical enterprise system 600 depicted in FIG. 6. The system 600 includes a data source 610, an external system 620, a network 630, a first access device 640 with a first user interface 645, and a second access device 650 with a second user interface 655. In some examples, the data source 610 and the external system 620 can be implemented in a single system. In some examples multiple data sources 610 and/or external systems 620 can be in communication via the network 630. The data source 610 and the external system 620 can communicate with one or more of the access devices 640, 650 via the network 630. One or more of the access devices 640, 650 can communicate with the data source 610 and/or the external system 620 via the network 630. In some examples, the access devices 640, 650 can communicate with one another via the network 630 using a communication interface (e.g., a wired or wireless communications connector/connection (e.g., a card, board, cable, wire, and/or other adapter, such as Ethernet, IEEE 1394, USB, serial port, parallel port, etc.). The network 630 can be implemented by, for example, the Internet, an intranet, a private network, a wired or wireless Local Area Network, a wired or wireless Wide Area Network, a cellular network, and/or any other suitable network.

The data source 610 and/or the external system 620 can provide images, reports, guidelines, best practices and/or other data to the access devices 640, 650 for review, options evaluation, and/or other applications. In some examples, the data source 610 can receive information associated with a session or conference and/or other information from the access devices 640, 650. In some examples, the external system 620 can receive information associated with a session or conference and/or other information from the access devices 640, 650. The data source 610 and/or the external system 620 can be implemented using a system such as a PACS, RIS, HIS, CVIS, EMR, archive, data warehouse, imaging modality (e.g., x-ray, CT, MR, ultrasound, nuclear imaging, etc.), payer system, provider scheduling system, guideline source, hospital cost data system, and/or other healthcare system.

The access devices 640, 650 can be implemented using a workstation (a laptop, a desktop, a tablet computer, etc.) or a mobile device, for example. Some mobile devices include smart phones (e.g., BLACKBERRY™, IPHONE™, etc.), Mobile Internet Devices (MID), personal digital assistants, cellular phones, handheld computers, tablet computers (IPAD™), etc., for example. In some examples, security standards, virtual private network access, encryption, etc., can be used to maintain a secure connection between the access devices 640, 650, data source 610, and/or external system 620 via the network 630.

The data source 610 can provide images and/or other data to the access device 640, 650. Portions, sub-portions, and/or individual images in a data set can be provided to the access device 640, 650 as requested by the access device 640, 650, for example. In certain examples, graphical representations (e.g., thumbnails and/or icons) representative of portions, sub-portions, and/or individual images in the data set are provided to the access device 640, 650 from the data source 610 for display to a user in place of the underlying image data until a user requests the underlying image data for review. In some examples, the data source 610 can also provide and/or receive results, reports, and/or other information to/from the access device 640, 650.

The external system 620 can provide/receive results, reports, and/or other information to/from the access device 640, 650, for example. In some examples, the external system 620 can also provide images and/or other data to the access device 640, 650. Portions, sub-portions, and/or individual images in a data set can be provided to the access device 640, 650 as requested by the access device 640, 650, for example. In certain examples, graphical representations (e.g., thumbnails and/or icons) representative of portions, sub-portions, and/or individual images in the data set are provided to the access device 640, 650 from the external system 620 for display to a user in place of the underlying image data until a user requests the underlying image data for review.

The data source 610 and/or external system 620 can be implemented using a system such as a PACS, RIS, HIS, CVIS, EMR, archive, data warehouse, imaging modality (e.g., x-ray, CT, MR, ultrasound, nuclear imaging, etc.).

In some examples, the access device 640, 650 can be implemented using a smart phone (e.g., BLACKBERRY™, IPHONE™, IPAD™, etc.), Mobile Internet device (MID), personal digital assistant, cellular phone, handheld computer, etc. The access device 640, 650 includes a processor retrieving data, executing functionality, and storing data at the access device 640, 650, data source 610, and/or external system 630. The processor drives a graphical user interface (GUI) 645, 655 providing information and functionality to a user and receiving user input to control the device 640, 650, edit information, etc. The GUI 645, 655 can include a touch pad/screen integrated with and/or attached to the access device 640, 650, for example. The device 640, 650 includes one or more internal memories and/or other data stores including data and tools. Data storage can include any of a variety of internal and/or external memory, disk, Bluetooth remote storage communicating with the access device 640, 650, etc. Using user input received via the GUI 645, 655 as well as information and/or functionality from the data and/or tools, the processor can navigate and access images and generate one or more reports related to activity at the access device 640, 650, for example. Reports can be processed to link external content to portions of the report and provide those links for user access and navigation within the report. The access device 640, 650 processor can include and/or communicate with a communication interface component to query, retrieve, and/or transmit data to and/or from a remote device, for example.

The access device 640, 650 can be configured to follow standards and protocols that mandate a description or identifier for the communicating component (including but not limited to a network device MAC address, a phone number, a GSM phone serial number, an International Mobile Equipment Identifier, and/or other device identifying feature). These identifiers can fulfill a security requirement for device authentication. The identifier is used in combination with a front-end user interface component that leverages an input device such as but not limited to; Personal Identification Number, Keyword, Drawing/Writing a signature (including but not limited to; a textual drawing, drawing a symbol, drawing a pattern, performing a gesture, etc.), etc., to provide a quick, natural, and intuitive method of authentication. Feedback can be provided to the user regarding successful/unsuccessful authentication through display of animation effects on a mobile device user interface. For example, the device can produce a shaking of the screen when user authentication fails. Security standards, virtual private network access, encryption, etc., can be used to maintain a secure connection.

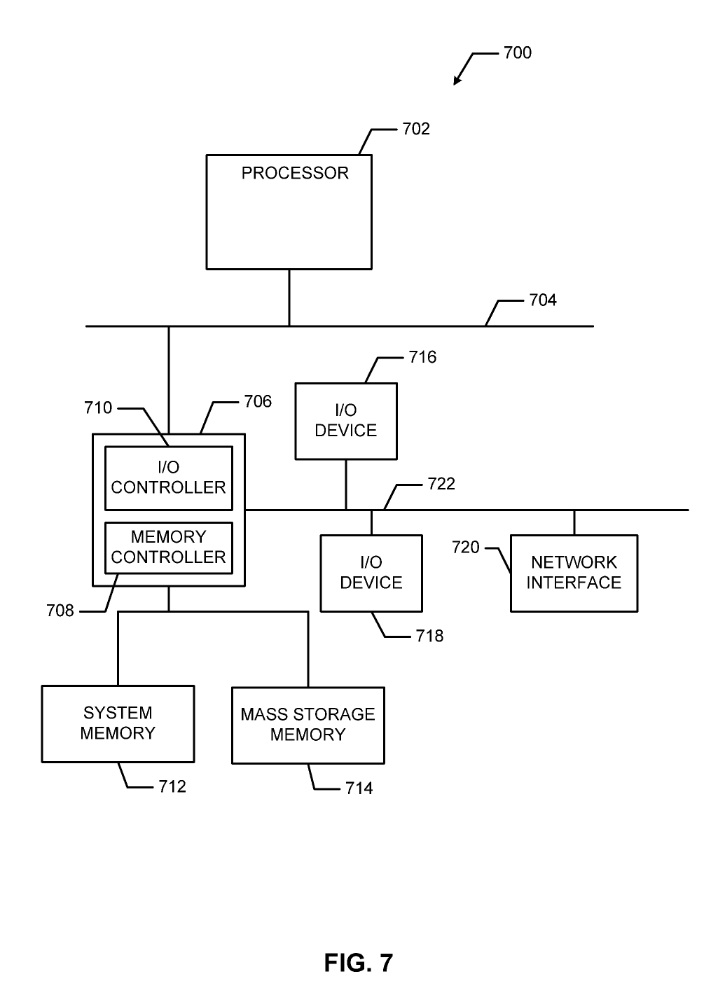

FIG. 7 is a block diagram of an example processor system 710 that may be used to implement the systems, apparatus and methods described herein. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Thus, certain examples provide systems, apparatus, and methods for automated processing of textual reports to identify elements in the report that are associated with external content and integrating those links into the report for later access by a user. Certain examples automatically identify words, phrases, icons, etc., in the report and triggers corresponding actions in the report based on the identified content. Certain examples help to alleviate manual steps to access applications, content, functionality, etc., for the benefit of readers of reports.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN), a wide area network (WAN), a wireless network, a cellular phone network, etc., that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method to automatically process report text to associate report text with external content, said method comprising:
automatically processing report text according to natural language processing of the text to identify a text element in the report associated with content external to the report;
associating the identified text element in the report with a link to the identified content external to the report to structure the report with reference to the external content; and
providing the structured report for access and manipulation by a user.

2. The method of claim 1, further comprising storing the structured report for later retrieval.

3. The method of claim 1, further comprising retrieving the report from storage for processing.

4. The method of claim 1, further comprising automatically processing the report text dynamically as the report is being generated.

5. The method of claim 1, wherein associating further comprises replacing the text element in the report with a semantic element associated with and linking to the external content.

6. The method of claim 1, wherein the external content comprises at least one of an image and a patient chart.

7. The method of claim 1, further comprising prompting a user to approve an association between the identified text element and the content external to the report.

8. The method of claim 1, further comprising integrating the structure report with a patient study.

9. A tangible computer-readable storage medium having a set of instructions stored thereon which, when executed, instruct a processor to implement a method to automatically process report text to associate report text with external content, the method comprising:
automatically processing report text according to natural language processing of the text to identify a text element in the report associated with content external to the report;
associating the identified text element in the report with a link to the identified content external to the report to structure the report with reference to the external content; and
providing the structured report for access and manipulation by a user.

10. The computer-readable storage medium of claim 9, wherein the method further comprises storing the structured report for later retrieval.

11. The computer-readable storage medium of claim 9, wherein the method further comprises retrieving the report from storage for processing.

12. The computer-readable storage medium of claim 9, wherein the method further comprises automatically processing the report text dynamically as the report is being generated.

13. The computer-readable storage medium of claim 9, wherein associating further comprises replacing the text element in the report with a semantic element associated with and linking to the external content.

14. The computer-readable storage medium of claim 9, wherein the external content comprises at least one of an image and a patient chart.

15. The computer-readable storage medium of claim 9, wherein the method further comprises prompting a user to approve an association between the identified text element and the content external to the report.

16. The computer-readable storage medium of claim 9, wherein the method further comprises integrating the structure report with a patient study.

17. A report processing system to facilitate automated natural language processing and external content association in a radiology report, said system comprising:
a memory to store data and instructions; and
a processor to:
automatically process report text according to natural language processing of the text to identify a text element in the report associated with content external to the report;
associate the identified text element in the report with a link to the identified content external to the report to structure the report with reference to the external content; and
provide the structured report for access and manipulation by a user.

18. The system of claim 17, wherein the processor is to retrieve the report from storage for processing.

19. The system of claim 17, wherein the processor is to automatically process the report text dynamically as the report is being generated.

20. The system of claim 17, wherein the processor is to prompt a user to approve an association between the identified text element and the content external to the report.
